(19) United States
(12) Patent Application Publication
(10) Pub. No.: US 2025/0224876 A1
(43) Pub. Date: Jul. 10, 2025

(54) MEMORY DEVICE INCLUDING INTERFACE CIRCUIT AND OPERATING METHOD THEREOF

(71) Applicant: Samsung Electronics Co., Ltd., Suwon-si (KR)

(72) Inventors: Hwanseok KU, Suwon-si (KR); Youngmin JO, Suwon-si (KR); Chiweon YOON, Suwon-si (KR); Anil KAVALA, Suwon-si (KR)

(73) Assignee: Samsung Electronics Co., Ltd., Suwon-si (KR)

(21) Appl. No.: 18/976,796

(22) Filed: Dec. 11, 2024

(30) Foreign Application Priority Data
Jan. 10, 2024 (KR) 10-2024-0004349

(51) Int. Cl. G06F 3/06

(52) U.S. Cl. CPC G06F 3/0613; G06F 3/0659; G06F 3/0679

(57) ABSTRACT

A memory device including a plurality of memory chips including a first memory chip and a second memory chip; and an interface circuit including a plurality of first-in first-out (FIFO) registers, the plurality of FIFO registers respectively corresponding to the plurality of memory chips. The memory device reads some data of the second memory chip and stores the read some data in a target FIFO register from among the FIFO registers of the interface circuit while reading data of the first memory chip, based on a clock signal and a command/address signal received from a memory controller. The target FIFO register is a FIFO register from among the FIFO registers corresponding to the second memory chip.

### CROSS-REFERENCE TO RELATED APPLICATION

This application is based on and claims priority under 35 U.S.C. § 119 to Korean Patent Application No. 10-2024-0004349, filed on Jan. 10, 2024, in the Korean Intellectual Property Office, the disclosure of which is incorporated by reference herein in its entirety.

### BACKGROUND

The inventive concepts relate to memory devices including an interface circuit and operating methods thereof.

Semiconductor memory devices can be classified into volatile memory devices in which, when the supply of power thereto is cut off, stored data is lost, and non-volatile memory devices in which, even when the supply of power thereto is cut off, stored data is not lost. Volatile memory devices have fast reading and writing speed, but when the supply of external power thereto is cut off, the stored content disappears. On the other hand, reading and writing speeds of non-volatile memory devices are slower than reading and writing speeds of volatile memory devices, but the content is preserved even if the supply of external power thereto is cut off.

Non-volatile memory devices, such as flash memory devices, are widely used as storage devices in various fields owing to the advantages of large capacity, low noise, and low power. In particular, a solid state drive/disk (SSD) device implemented based on flash memory devices is used as a large-capacity storage device in personal computers, laptops, workstations, and server systems. SSD devices according to the related art are connected to a computing system based on a serial advanced technology attachment (ATA) (SATA) interface or peripheral component interconnection (PCI)-express interface. Recently, a separate command address (SCA) protocol in which a command/address signal and a data signal are separated from each other and are transmitted to a memory device so that the command/address signal can be transmitted to the memory device during direct memory access (DMA), has been introduced to solve an input/output (I/O) efficiency saturation phenomenon. However, despite the introduction of the SCA protocol, I/O efficiency cannot be increased (and/or maximized) due to the delay time (e.g., async time etc. caused by a command/address signal or a header signal) that occurs during signal transmission and reception in a memory device.

### SUMMARY

Some example embodiments of the inventive concepts provide a memory device including an interface circuit, a memory system, and an operating method thereof, whereby input/output (I/O) efficiency may be increased (and/or maximized) using the interface circuit.

The technical objectives of the inventive concepts are not limited to the aforementioned technical objectives, and other technical objectives not mentioned can be clearly understood by a person skilled in the art from the following description.

Some example embodiments of the inventive concepts provide a memory device that includes a plurality of memory chips including a first memory chip and a second memory chip; and an interface circuit including a plurality of first-in first-out (FIFO) registers, the plurality of FIFO registers respectively corresponding to the plurality of memory chips. The memory device reads some data of the second memory chip and stores the read some data in a target FIFO register from among the plurality of FIFO registers of the interface circuit while reading data of the first memory chip, based on a clock signal and a command/address signal received from a memory controller, and the target FIFO register is a FIFO register from among the plurality of FIFO registers corresponding to the second memory chip.

Some example embodiments of the inventive concepts further provided an operating method of a memory device, the memory device including an interface circuit and a plurality of memory chips. The operating method includes receiving a clock signal and a command/address signal from a memory controller; reading some data of a second memory chip from among the plurality of memory chips in advance while reading data of a first memory chip from among the plurality of memory chips based on the command/address signal; and storing the read some data of the second memory chip in the interface circuit.

Some example embodiments of the inventive concepts still further provide a memory system that includes a memory device including a plurality of non-volatile memory chips and an interface circuit, the interface circuit including a plurality of first-in first-out (FIFO) registers respectively corresponding to the plurality of non-volatile memory chips; and a memory controller connected to the interface circuit, the memory controller transmitting and receiving data. The memory device reads some data of a second non-volatile memory chip from among the plurality of non-volatile memory chips in advance and stores the read some data in a target FIFO register from among the plurality of FIFO registers while reading data of a first non-volatile memory chip from among the plurality of non-volatile memory chips, and the target FIFO register is a FIFO register from among the plurality of FIFO registers corresponding to the second non-volatile memory chip.

### BRIEF DESCRIPTION OF THE DRAWINGS

Embodiments will be more clearly understood from the following detailed description taken in conjunction with the accompanying drawings in which:

FIG. 1 illustrates a data processing system according to some example embodiments of the inventive concepts;

FIG. 2 illustrates a memory device according to a comparative embodiment;

FIG. 3 illustrates a memory device according to some example embodiments;

FIG. 4A illustrates an example of a clock diagram of a memory device according to some example embodiments;

FIG. 4B illustrates an example of a memory device according to some example embodiments;

FIG. 4C illustrates an example of a memory device according to some example embodiments;

FIG. 4D illustrates an example of a memory device according to some example embodiments;

FIG. 5 is a flowchart illustrating an operating method of a memory device according to some example embodiments;

FIG. 6 is a comparison diagram between a memory device according to some example embodiments and a memory device according to a comparative embodiment;

FIG. 7 illustrates a computing system according to some example embodiments; and

FIG. 8 illustrates a solid state drive (SSD) system according to some example embodiments.

### DETAILED DESCRIPTION

Hereinafter, embodiments of the inventive concepts will be described in detail with reference to the accompanying drawings. Embodiments of the inventive concepts are illustrated in the drawings, and the related detailed descriptions are described therein, but this is not intended to limit the various embodiments of the inventive concepts in a specific form. For example, the fact that the embodiments of the inventive concepts can be changed in various ways are clearly obvious to those of ordinary skill in the art of the inventive concepts.

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

Also, for example, “at least one of A, B, and C” and similar language (e.g., “at least one selected from the group consisting of A, B, and C”) may be construed as A only, B only, C only, or any combination of two or more of A, B, and C, such as, for instance, ABC, AB, BC, and AC.

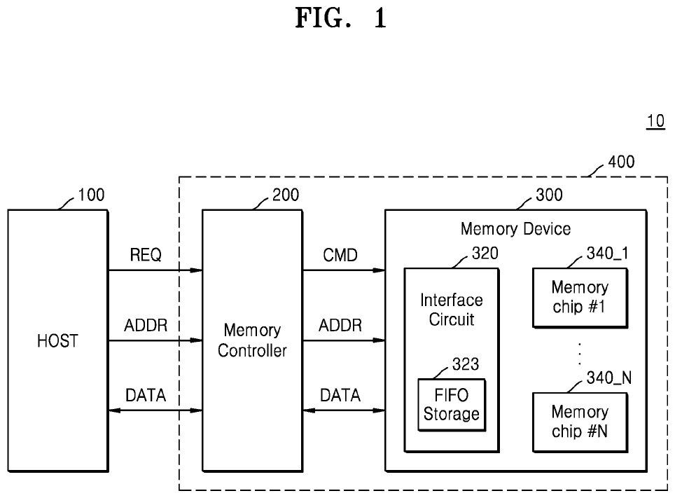

FIG. 1 illustrates a data processing system 10 according to some example embodiments of the inventive concepts.

The data processing system 10 may include a host 100 and a memory system 400, and the memory system 400 may include a memory controller 200 and a memory device 300. The data processing system 10 may be applied to one of various computing systems, such as an ultra mobile personal computer (UMPC), a workstation, a netbook, a personal digital assistant (PDA), a portable computer, a web tablet, a wireless phone, a mobile phone, a smartphone, an e-book, a portable multimedia player (PMP), a portable game device, a navigation device, a black box, a digital camera, and the like.

Each of the host 100, the memory controller 200, and the memory device 300 may be provided as one chip, one package, one module, or the like. However, some example embodiments are not limited thereto. For example, the memory controller 200 may be provided as the memory system 400 with the memory device 300, or a storage device.

The memory system 400 may constitute a personal computer (PC) card, a compact flash (CF) card, a smart media card (SM/SMC), a memory stick, a multi media card (MMC) such as reduced size multi media card (RS-MMC) and MMCmicro, a secure digital (SD) card such as SD, miniSD, and microSD, an universal flash storage (UFS), and the like. In some example embodiments, the memory system 400 may also constitute a solid state disk/drive (SSD).

The host 100 may transmit a data operation request REQ and an address ADDR to the memory controller 200, and may exchange data DATA with the controller 200. For example, the host 100 may exchange the data DATA with the memory controller 200 based on at least one of various interface protocols, such as a universal serial bus (USB) protocol, a multi media card (MMC) protocol, a peripheral component interconnection (PCI) protocol, a PCI-Express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a mobile industry processor interface (MIPI) protocol, a universal flash storage (UFS) protocol, and the like.

The memory controller 200 may control the memory device 300. For example, the memory controller 200 may control the memory device 300 to read data DATA stored in the memory device 300 or to write data DATA into the memory device 300 in response to the data operation request REQ received from the host 100. For example, the memory controller 200 may control a write operation, a read operation, and an erase operation, and the like of the memory device 300 by providing an address ADDR, a command CMD, a control signal, and the like to the memory device 300. The data DATA for the above-described operations may be transmitted/received to/from the memory controller 200 and the memory device 300. In some example embodiments, the memory controller 200 may provide a read-enable signal to the memory device 300.

The memory device 300 may include at least one memory chip (or memory die), and for example, the memory device 300 may include a plurality of memory chips. For example, the memory device 300 may include a first memory chip 340_1 through a N-th memory chip 340_N (where N is a natural number that is greater than or equal to 2). A memory chip may also be referred to as a memory way. Each of the first memory chip 340_1 through the N-th memory chip 340_N may include at least one memory cell array. The memory cell array may include a plurality of memory cells arranged in a region in which a plurality of word lines and a plurality of bit lines cross one another, and the plurality of memory cells may respectively be non-volatile memory cells. Each memory cell may be a multi-level cell in which 2-bit or more data is stored. For example, each memory cell may be a 2-bit multi-level cell for storing 2-bit data, a triple level cell (TLC) for storing 3-bit data, a quadruple level cell (QLC) for storing 4-bit data, or a multi-level cell for storing 4-bit or more data. However, some example embodiments are not limited thereto, and for example, some memory cells may be single level cells (SLCs) for storing 1-bit data, and the other memory cells may be multi-level cells. The memory device 300 may include a negative AND (NAND) flash memory device, a vertical NAND (VNAND) memory device, a NOR flash memory device, a resistive random access memory (RRAM) device, a phase-change random access memory (PRAM) device, a magnetoresistive random access memory (MRAM) device, a ferroelectric random access memory (FRAM) device, a spin transfer torque random access memory (STT-RAM) device, and the like and may include a combination thereof. In some example embodiments, the memory device 300 may have a structure stacked to 100 or more layers. In some example embodiments, the memory device 300 may have a cell-on-peri or cell-over-peri (COP) structure. The memory device 300 may perform operations such as a write operation, a read operation, and an erase operation of the data DATA in response to signals received from the memory controller 200. In some example embodiments, the memory device 300 may generate a data strobe signal based on the read-enable signal (e.g., an external clock signal) provided from the memory controller 200. In some example embodiments, the memory device 300 may provide the data strobe signal generated based on the read-enable signal (e.g., an external clock signal) to the memory controller 200.

In some example embodiments, the operating frequency of the memory device 300 may be 1 GHz or more.

The memory device 300 may include an interface circuit 320. The interface circuit 320 may buffer at least one signal input from the outside of the memory device 300. For example, the interface circuit 320 may store a data operation control signal and/or the command CMD, wherein the data operation control signal is generated based on the command CMD provided from the memory controller 200. The interface circuit 320 may also be referred to as a buffer chip or a buffer circuit. The interface circuit 320 may also be referred to as a frequency boosting interface (FBI) circuit. In some example embodiments, the first through N-th memory chips 340_1 through 340_N and the interface circuit 320 may be implemented as a single package. However, some example embodiments are not limited thereto, and the first through N-th memory chips 340_1 to 340_N and the interface circuit 320 may also be respectively implemented as different packages.

The interface circuit 320 may connect the first through N-th memory chips 340_1 to 340_N and the memory controller 200 to each other. For example, the interface circuit 320 may store data signals output by the first through N-th memory chips 340_1 to 340_N temporarily and may output the data signals as read data to the memory controller 200.

In some example embodiments, the interface circuit 320 may select a specific memory chip from a plurality of memory chips, based on the command CMD received from the memory controller 200, the address ADDR, and/or a chip selection signal, thereby transmitting a command/address signal and a read-enable signal to the specific memory chip. For example, the interface circuit 320 may transmit the command/address signal and the read-enable signal to the first memory chip 340_1, and the first memory chip 340_1 may transmit the read data read from the first memory chip 340_1 to the interface circuit 320 according to a data strobe signal (generated based on the read-enable signal) in response to the reception of the command/address signal.

In some example embodiments, the interface circuit 320 may include a first-in first-out (FIFO) storage 323 including a plurality of FIFO registers. The FIFO storage 323 may simultaneously store data (or data signals) of the first through N-th memory chips 340_1 to 340_N (referred to FIG. 1) based on the plurality of FIFO registers. Each of the plurality of FIFO registers may correspond to each of the plurality of memory chips. Each of the plurality of FIFO registers may be electrically connected to a corresponding memory chip and may receive a data signal and a data strobe signal from a corresponding memory chip through the connection. Each of the plurality of FIFO registers may store read data of a corresponding memory chip. For example, the interface circuit 320 may include first through N-th FIFO registers, and the first FIFO register may store read data of the first memory chip 340_1 corresponding to the first FIFO register and the N-th FIFO register may store read data of the N-th memory chip 340_N corresponding to the N-th FIFO register.

The interface circuit 320 may control an other memory chip so that a read operation may be performed on the other memory chip while a read operation is performed on a specific memory chip. For example, the interface circuit 320 may transmit a command/address signal and a read-enable signal to a second memory chip (not shown) while the read operation is performed on the first memory chip 340_1. The memory device 300 may read some data of the second memory chip (not shown) based on the command/address signal and the read-enable signal in advance, thereby storing the read data in the interface circuit 320. In some example embodiments, some read data of the second memory chip (not shown) may be stored in a FIFO register corresponding to the second memory chip (not shown) among the plurality of FIFO registers included in the interface circuit 320.

In the memory device 300 including the interface circuit 320 and an operating method thereof according to some example embodiments, the interface circuit 320 may include a plurality of FIFO registers that respectively correspond to the plurality of memory chips (or a plurality of memory dies) (e.g., 340_1 to 340_N). The memory device 300 may perform a read operation on another memory chip (e.g., the second memory chip (not shown)) while a read operation is performed on one memory chip (e.g., the first memory chip 340_1) based on the plurality of FIFO registers.

Thus, the memory device 300 may perform the operation of another memory chip (e.g., the second memory chip (not shown)) overlappingly during the operation time of one memory chip (e.g., the first memory chip 340_1), thereby reducing and/or minimizing the standby time (e.g., async time of a command/address signal and a header signal) that occurs when a data read operation is performed on the plurality of memory chips and reducing and/or minimizing the total operating time of the memory device 300. Furthermore, as the total operating time of the memory device 300 is reduced, an input/output efficiency of the memory device 300 and the memory system 400 may be increased (and/or maximized).

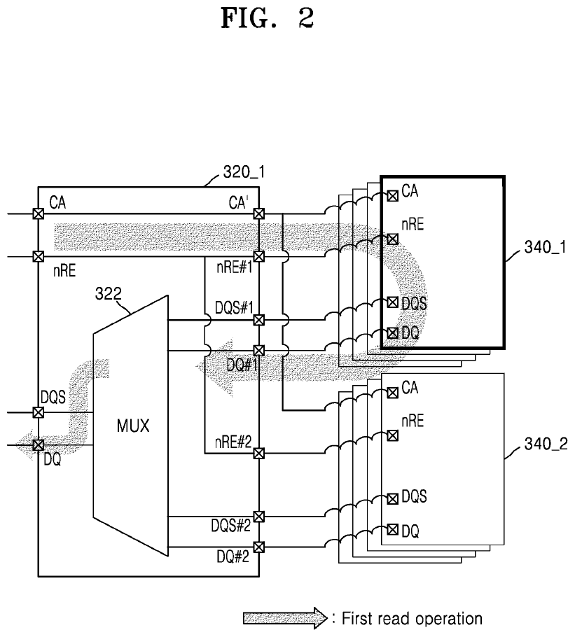

FIG. 2 illustrates a memory device according to a comparative embodiment.

The arrow that is darkly hatched in FIG. 2 means the first read operation in which data of the first memory chip 340_1 is read and output, and it is assumed that the memory device according to the comparative embodiment is a memory device to which a separate command address (SCA) protocol is applied.

In FIG. 2, an interface circuit 320_1 of the memory device according to the comparative embodiment may receive a command/address signal from the memory controller via a CA pin and may receive a read-enable signal (e.g., a clock signal) from the memory controller via an nRE pin. The first memory chip 340_1 and the second memory chip 340_2 may generate a data strobe signal based on the received read-enable signal (e.g., a clock signal) and may output the read data of each memory chip as a data signal in synchronization with the data strobe signal.

The interface circuit 320_1 may receive the data strobe signal of the first memory chip 340_1 via a DQS #1 pin and may receive a data strobe signal of the second memory chip 340_2 via a DQS #2 pin. The interface circuit 320_1 may receive the data signal including data of the first memory chip 340_1 via a DQ #1 pin and may receive a data signal including data of the second memory chip 340_2 via a DQ #2 pin. The interface circuit 320_1 may transmit the data strobe signal of the first memory chip 340_1 and/or the data strobe signal of the second memory chip 340_2 to the memory controller via a DQS pin and may transmit the data signal of the first memory chip 340_1 and/or the data signal of the second memory chip 340_2 to the memory controller via a DQ pin.

Referring to FIG. 2, in the memory device according to the comparative embodiment, the interface circuit 320_1 may transmit a command/address signal from the CA pin of the interface circuit 320_1 to the CA pin of the first memory chip 340_1 and may transmit a read-enable signal from the nRE #1 pin of the interface circuit 320_1 to the nRE pin of the first memory chip 340_1. The first memory chip 340_1 may generate a first data strobe signal based on the received read-enable signal and may transmit the first data strobe signal to the DQS #1 pin of the interface circuit 320_1 from the DQS pin of the first memory chip 340_1. The first memory chip 340_1 may transmit data of the first memory chip 340_1 to the interface circuit 320_1 in synchronization with a rising edge and a falling edge of the first data strobe signal. The data signal including the data of the first memory chip 340_1 may be transmitted to the DQ #1 pin of the interface circuit 320_1 from the DQ pin of the first memory chip 340_1. The interface circuit 320_1 may select (e.g., muxing) the data signal of the first memory chip 340_1 among the plurality of memory chips based on a multiplexer MUX 322 and may output the selected data signal of the first memory chip 340_1 to the memory controller via the DQ pin. The interface circuit 320_1 may perform the above-described operations repeatedly so as to read the data of the second memory chip 340_2 after outputting the data signal of the first memory chip 340_1.

In the memory device according to the comparative embodiment, in a read operation on the plurality of memory chips, only the memory chip selected based on a simple muxing method needs to output data and the remaining memory chips need to be on standby. Each of the remaining memory chips may read the data by receiving the command/address signal from the interface circuit 320_1 and may output the read data to the memory controller via the interface circuit 320_1 until each memory chip has its own turn.

Thus, in the memory device according to the comparative embodiment, in a read operation on the plurality of memory chips, as a read operation is sequentially performed on each memory chip, the standby time (e.g., dummy time such as async time or the like) for the command/address signal (or header signal) occurs in each memory chip, and thus the total data operating time of the memory device may increase.

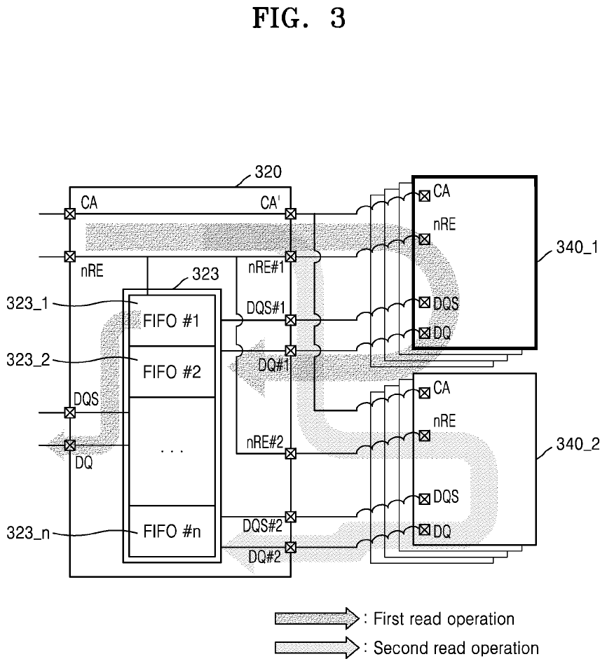

The memory device 300 according to some example embodiments may perform a read operation between the plurality of memory chips based on FIFO registers of the interface circuit 320 overlappingly, thereby reducing and/or minimizing the standby time (e.g., dummy time such as async time or the like) of the command/address signal (or a header signal) in each memory chip and enhancing total operating speed of the memory device 300. Detailed descriptions thereof are provided below with reference to FIGS. 3 through 7.

FIG. 3 illustrates a memory device according to some example embodiments.

The arrow that is darkly hatched in FIG. 3 means a first read operation in which the data of a first memory chip 340_1 is read and output and the lightly-hatched arrow means a second read operation in which the data of a second memory chip 340_2 is read and output, assuming that the memory device 300 is a memory device to which an SCA protocol is applied.

In FIG. 3, the interface circuit 320 of the memory device according to some example embodiments may receive a command/address signal from the memory controller via a CA pin and may receive a read-enable signal (e.g., a clock signal) from the memory controller via an nRE pin. The first memory chip 340_1 and the second memory chip 340_2 may generate a data strobe signal based on the received read-enable signal (e.g., a clock signal) and may output the read data of each memory chip as a data signal in synchronization with the data strobe signal.

The interface circuit 320 may receive the data strobe signal of the first memory chip 340_1 via a DQS #1 pin and may receive a data strobe signal of the second memory chip 340_2 via a DQS #2 pin. The interface circuit 320 may receive the data signal including data of the first memory chip 340_1 via a DQ #1 pin and may receive a data signal including data of the second memory chip 340_2 via a DQ #2 pin. The interface circuit 320 may transmit the data strobe signal of the first memory chip 340_1 and/or the data strobe signal of the second memory chip 340_2 to the memory controller via a DQS pin and may transmit the data signal of the first memory chip 340_1 and/or the data signal of the second memory chip 340_2 to the memory controller via a DQ pin.

Referring to FIG. 3, in the memory device 300 according to some example embodiments, the interface circuit 320 may transmit a command/address signal from a CA pin of the interface circuit 320 to a CA pin of the first memory chip 340_1 and may transmit a read-enable signal from an nRE #1 pin of the interface circuit 320 to an nRE pin of the first memory chip 340_1. The first memory chip 340_1 may generate a first data strobe signal based on the received read-enable signal and may transmit the first data strobe signal to the DQS #1 pin of the interface circuit 320_1 from the DQS pin of the first memory chip 340_1. The first memory chip 340_1 may transmit data of the first memory chip 340_1 to the interface circuit 320 in synchronization with a rising edge and a falling edge of the first data strobe signal. The data of the first memory chip 340_1 may be transmitted to the DQ #1 pin of the interface circuit 320 from the DQ pin of the first memory chip 340_1.

The interface circuit 320 according to some example embodiments may include a plurality of FIFO registers (e.g., a first FIFO register FIFO #1 (323_1) to an N-th FIFO register FIFO #n (323_n) in the FIFO storage 323, and each of the plurality of FIFO registers (e.g., the first FIFO register FIFO #1 (323_1) to the N-th FIFO register FIFO #n (323_n)) may correspond to one of a plurality of memory chips included in the memory device 300. For example, the first FIFO register FIFO #1 (323_1) may correspond to the first memory chip 340_1 and the second FIFO register FIFO #2 (323_2) may correspond to the second memory chip 340_2. In FIG. 2, for convenience of explanation, only the first memory chip 340_1 and the second memory chip 340_2 are shown. However, the memory device 300 according to some example embodiments is not limited thereto.

The interface circuit 320 may transmit the command/address signal to the CA pin of the second memory chip 340_2 from the CA pin of the interface circuit 320 in advance while reading data from the first memory chip 340_1 and may transmit the read-enable signal (in some example embodiments, the read-enable signal includes a read-enable signal used in a read operation of the first memory chip 340_1) from the nRE #2 pin of the interface circuit 320 to the nRE pin of the second memory chip 340_2 in advance. The second memory chip 340_2 may generate a second data strobe signal based on the received read-enable signal and may transmit the second data strobe signal to the DQS #2 pin of the interface circuit 320 from the DQS pin of the second memory chip 340_2. The second memory chip 340_2 may transmit a data signal including the data of the second memory chip 340_2 to the interface circuit 320 in advance in synchronization with a rising edge and a falling edge of the second data strobe signal. In some example embodiments, the size of the data (or some data) of the second memory chip 340_2 may correspond to the size of a target FIFO register (e.g., the second FIFO register FIFO #2 (323_2). The interface circuit 320 may store the data signal including the data (or some data) of the second memory chip 340_2 in a target FIFO register (e.g., FIFO #2). Here, the target FIFO register may mean a FIFO register (e.g., the second FIFO register FIFO #2 (323_2)) corresponding to the second memory chip 340_2 among the plurality of FIFO registers (e.g., the first FIFO register FIFO #1 (323_1) to the N-th FIFO register FIFO #n (323_n)) included in the interface circuit 320. That is, the memory device 300 may read (overlappingly operate) the data (or some data) of the second memory chip 340_2 in advance while reading the data of the first memory chip 340_1, thereby storing the data in the target FIFO register (e.g., the second FIFO register FIFO #2 (323_2)) of the interface circuit 320.

The interface circuit 320 may output the data signal of the first memory chip 340_1 to the memory controller via the DQ pin. The interface circuit 320 may output a data signal including data (or some data) of the second memory chip 340_2 stored in the target FIFO register (e.g., the second FIFO register FIFO #2 (323_2)) to the memory controller via the DQ pin in response to the reception of a first FIFO operation command from the memory controller after outputting the data signal of the first memory chip 340_1. The interface circuit 320 may read the remaining data of the second memory chip 340_2 in response to the reception of the second FIFO operation command from the memory controller, thereby storing the remaining data of the target FIFO chip (e.g., the second FIFO register FIFO #2 (323_2)). The interface circuit 320 may control the data signal including the remaining data of the second memory chip 340_2 stored in the target FIFO register (e.g., the second FIFO register FIFO #2 (323_2)) to the memory controller via the DQ pin after outputting the data signal including data (or some data) of the second memory chip 340_2 stored in the target FIFO register (e.g., the second FIFO register FIFO #2 (323_2)).

The memory device 300 according to some example embodiments may perform the read operation (or some of the read operation) on the second memory chip 340_2 overlappingly while performing the read operation of the first memory chip 340_1, thereby reducing and/or minimizing the standby time (e.g., async time) caused by the command/address signal (or header signal) that occurs in each memory chip and thus reducing and/or minimizing the total operating time of the memory device 300 to increase (and/or maximize) I/O efficiency.

As the memory device 300 according to some example embodiments performs the read operation on the plurality of memory chips (e.g., the first memory chip 340_1 and the second memory chip 340_2) described above based on a clock signal (e.g., a read-enable signal) received from the memory controller, an additional device/additional circuit for clock synchronization between the memory controller and the plurality of memory chips (e.g., the first memory chip 340_1 and the second memory chip 340_2) is not required, hardware resources may be saved, and power consumption for driving the additional device/additional circuit may be limited and/or prevented.

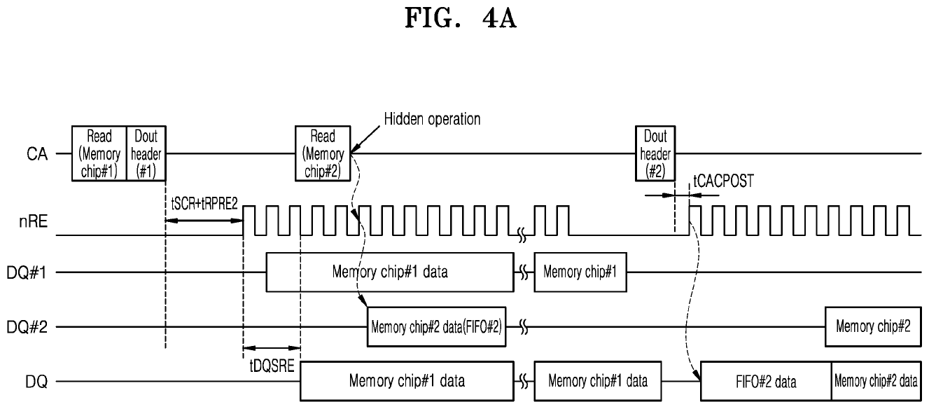

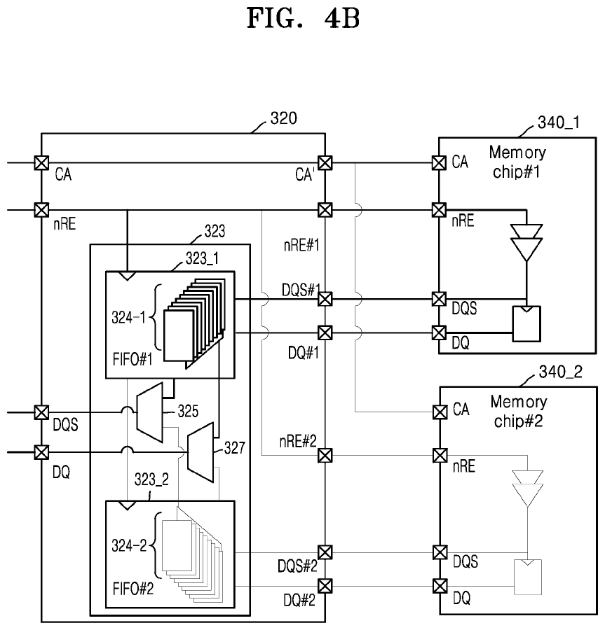

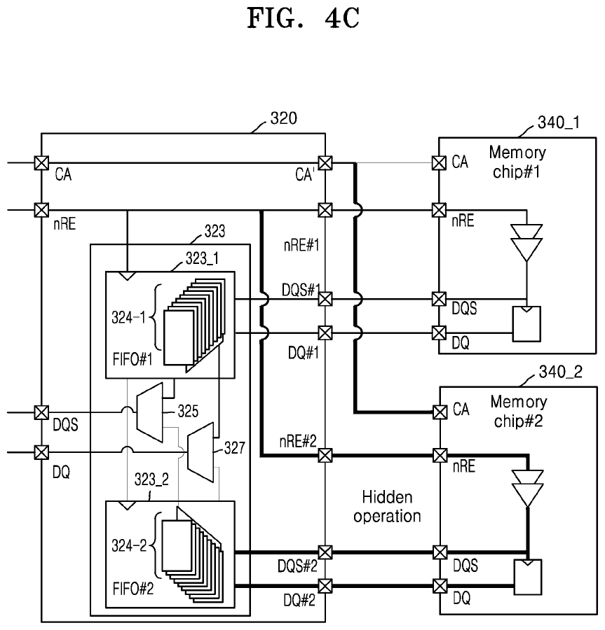

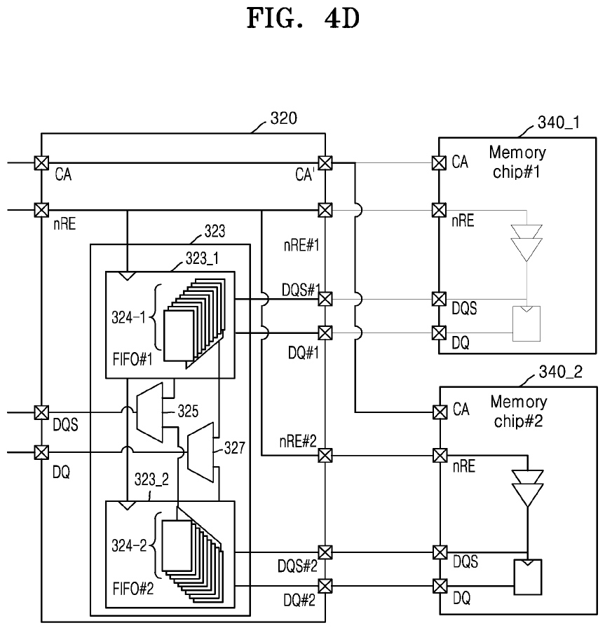

FIG. 4A illustrates an example of a timing diagram of a memory device according to some example embodiments.

FIGS. 4B through 4D illustrate an example of a memory device according to some example embodiments.

For example, FIG. 4A is a timing diagram of the memory device according to some example embodiments, and FIGS. 4B through 4D may represent the operation of the memory device 300 at a specific time of the timing diagram of FIG. 4A. The descriptions of FIGS. 4A through 4D redundant with the descriptions of FIGS. 1 through 3 are omitted.

Referring to FIGS. 4A and 4B, the interface circuit 320 may transmit a Read (Memory chip #1) command and Dout header (#1) received from the memory controller to the CA pin of the first memory chip 340_1 via the CA pin. The interface circuit 320 may transmit the read-enable signal (e.g., a clock signal) received from the memory controller to the nRE pin of the first memory chip 340_1 via the nRE #1 pin. In the first memory chip 340_1, the read-enable signal may toggle between a high level and a low level according to a desired (and/or alternatively pre-determined) period after (tSCR+tRPRE2) (˜about 70 ns) has been elapsed from the reception time of Dout header (#1). The first memory chip 340_1 may read data of the first memory chip 340_1 based on the read-enable signal. For example, the first memory chip 340_1 may generate a data strobe signal based on the read-enable signal. The first memory chip 340_1 may output the data strobe signal to the DQS #1 pin of the interface circuit 320 from the DQS pin. The first memory chip 340_1 may output the data signal (hereinafter, referred to as a data signal of the first memory chip 340_1) including data of the first memory chip 340_1 to the interface circuit 320 in synchronization with the data strobe signal. For example, the first memory chip 340_1 may output the data signal of the first memory chip 340_1 to the DQ #1 pin of the interface circuit 320 from the DQ pin. The interface circuit 320 may store the received data signal of the first memory chip 340_1 in the first FIFO register 323_1 in the FIFO storage 323. The first FIFO register 323_1 that is a FIFO register corresponding to the first memory chip 340_1 among the plurality of FIFO registers included in the FIFO storage 323 may include a plurality of latch circuits 324_1, and the second FIFO register 323_2 that is a FIFO register corresponding to the second memory chip 340_2 among the plurality of FIFO registers included in the FIFO storage 323 may include a plurality of latch circuits 324_2. The FIFO storage 323 may include a plurality of FIFO registers (e.g., the first FIFO register 323_1, the second FIFO register 323_2, . . . , and a N-th FIFO register (not shown)), a first MUX 325 connected to the DQS pin of the interface circuit 320, and a second MUX 327 connected to the DQ pin of the interface circuit 320. However, the FIFO storage 323 according to some example embodiments is not limited thereto and may further include additional components. The interface circuit 320 may output the data signal of the first memory chip 340_1 to the memory controller via the DQ pin after tDQSRE has elapsed from a toggle start time of the read-enable signal in the first memory chip 340_1.

Referring to FIGS. 4A and 4C, the interface circuit 320 may transmit the command/address signal and the read-enable signal (e.g., a clock signal) to the second memory chip 340_2 in advance while reading the data of the first memory chip 340_1 (e.g., the memory device 300 performs a read operation (a hidden operation) of the second memory chip 340_2 during the read operation of the first memory chip 340_1). For example, the interface circuit 320 may transmit a Read (Memory chip #2) command received from the memory controller to the CA pin of the second memory chip 340_2 via the CA pin. The interface circuit 320 may transmit the read-enable signal (see FIG. 4B) received from the memory controller to the nRE pin of the second memory chip 340_2 via the nRE #2 pin in advance so as to be used in the read operation of the second memory chip 340_2. The second memory chip 340_2 may read some data (the size of the second FIFO register 323_2) of the second memory chip 340_2 based on the received read-enable signal in advance while the data of the first memory chip 340_1 is being read. For example, the second memory chip 340_2 may generate a data strobe signal based on the read-enable signal. The second memory chip 340_2 may output the data strobe signal to the DQS #2 pin of the interface circuit 320 from the DQS pin while the data of the first memory chip 340_1 is being read. The second memory chip 340_2 may output the data signal (hereinafter, referred to as a first data signal of the second memory chip 340_2) including some data of the second memory chip 340_2 in synchronization with the data strobe signal while the data of the first memory chip 340_1 is being read. For example, the second memory chip 340_2 may output the first data signal of the second memory chip 340_2 to the DQ #2 pin of the interface circuit 320 from the DQ pin while the data of the first memory chip 340_1 is being read. The interface circuit 320 may store the first data signal of the second memory chip 340_2 in a target FIFO register (e.g., the second FIFO register 323_2) in the FIFO storage 323 while the data of the first memory chip 340_1 is being read. The second FIFO register 323_2 that is a FIFO register corresponding to the second memory chip 340_2 among the plurality of FIFO registers included in the FIFO storage 323 may include a plurality of latch circuits 324_2. The FIFO storage 323 may include a plurality of FIFO registers (e.g., the first FIFO register 323_1, the second FIFO register 323_2, . . . , and a N-th FIFO register (not shown)), a first MUX 325 connected to the DQS pin of the interface circuit 320, and a second MUX 327 connected to the DQ pin of the interface circuit 320. However, the FIFO storage 323 according to some example embodiments is not limited thereto and may further include additional components.

Referring to FIGS. 4A and 4D, the interface circuit 320 may transmit a Read (Memory chip #2) command (not shown) and Dout header (#2) received from the memory controller from the CA pin to the CA pin of the second memory chip 340_2 via the CA pin. The interface circuit 320 may transmit the read-enable signal (e.g., a clock signal) received from the memory controller to the nRE pin of the second memory chip 340_2 via the nRE #2 pin. In the second memory chip 340_2, the read-enable signal may toggle between a high level and a low level according to a desired (and/or alternatively pre-determined) period after tCACPOST (˜about 10 ns) has elapsed from the reception time of Dout header (#2). For example, unlike in the read operation of the first memory chip 340_1, it may be checked that a standby time (e.g., tSCR+tSCZ+tRPRE2) does not occur due to the command/address signal and the header signal during the read operation of the second memory chip 340_2. The interface circuit 320 may output the first data signal (including some data previously read from the second memory chip 340_2 while the data of the first memory chip 340_1 was being read) of the second memory chip 340_2 stored in the target FIFO register (e.g., the second FIFO register 323_2) to the memory controller in response to the reception of the Read (Memory chip #2) command (not shown) and Dout header (#2) received from the memory controller. For example, the interface circuit 320 may output the first data signal of the second memory chip 340_2 to the memory controller via the DQ pin after tCACPOST (˜about 10 ns) has elapsed from the reception time of Dout header (#2). That is, it may be checked that when the first data signal of the second memory chip 340_2 is read, tDQSRE does not occur. In the description above, the occurrence of tCACPOST (˜about 10 ns) has been described as a premise. However, some example embodiments are not limited thereto, and tCACPOST (˜about 10 ns) may not occur depending on the command setting.

The second memory chip 340_2 may read the remaining data of the second memory chip 340_2 based on the read-enable signal. Here, the remaining data of the second memory chip 340_2 may refer to the remaining data of the second memory chip 340_2 excluding some data of the second memory chip 340_2, which was previously read while the data of the first memory chip 340_1 was being read. For example, the second memory chip 340_2 may generate a data strobe signal based on the read-enable signal. The second memory chip 340_2 may output the data strobe signal to the DQS #2 pin of the interface circuit 320 from the DQS pin. The second memory chip 340_2 may output the data signal (hereinafter, referred to as a data signal of the second memory chip 340_2) including data of the second memory chip 340_2 to the interface circuit 320 in synchronization with the data strobe signal. For example, the second memory chip 340_2 may output the second data signal of the second memory chip 340_2 to the DQ #2 pin of the interface circuit 320 from the DQ pin. The interface circuit 320 may store the received second data signal of the second memory chip 340_2 in the target FIFO register (e.g., the second FIFO register 323_2) in the FIFO storage 323. The second FIFO register 323_2 that is a FIFO register corresponding to the second memory chip 340_2 among the plurality of FIFO registers included in the FIFO storage 323 may include a plurality of latch circuits 324_2. The FIFO storage 323 may include a plurality of FIFO registers (e.g., the first FIFO register 323_1, the second FIFO register 323_2, . . . , and a N-th FIFO register (not shown)), a first MUX 325 connected to the DQS pin of the interface circuit 320, and a second MUX 327 connected to the DQ pin of the interface circuit 320. However, the FIFO storage 323 according to some example embodiments is not limited thereto and may further include additional components. The interface circuit 320 may output the second data signal of the second memory chip 340_2 to the memory controller via the DQ pin after outputting the first data signal of the second memory chip 340_2.

In the memory device 300 and the operating method thereof according to some example embodiments, as the read operation (or some of the read operation) of the second memory chip 340_2 is overlappingly performed during the read operation of the first memory chip 340_1, the standby time (e.g., async time for the command/address signal and the header signal) that occurs during the read operation of each memory chip may be reduced (and/or minimized).

Furthermore, in the memory device 300 and the operating method thereof according to some example embodiments, the total operating time of the memory device 300 may be reduced so that the I/O efficiency of the whole memory device 300 may be increased (and/or maximized).

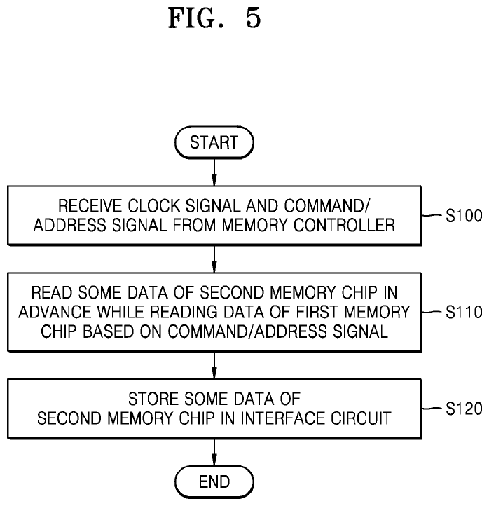

FIG. 5 is a flowchart illustrating an operating method of a memory device 300 according to some example embodiments.

Referring to FIG. 5, a read (e.g., multichip-interleaving) operating method of a plurality of memory chips based on the FIFO storage of the memory device 300 may include operations S100 to S120. The description of FIG. 5 redundant with the description of FIGS. 1 through 4D will be replaced with the description of FIGS. 1 through 4D. A memory device 300, an interface circuit 320, a first memory chip 340_1, and a second memory chip 340_2 of FIG. 5 correspond to the memory device 300, the interface circuit 320, the first memory chip 340_1, and the second memory chip 340_2 of FIGS. 1 through 4D, respectively.

In operation S100, the memory device 300 including the interface circuit 320 and a plurality of memory chips may receive a clock signal and a command/address signal from the memory controller. For example, the interface circuit 320 may transmit the clock signal and the command/address signal received from the memory controller, to the first memory chip 340_1. Here, the clock signal may mean a read-enable signal received from the memory controller. The interface circuit 320 may include a FIFO storage including a plurality of FIFO registers respectively corresponding to the plurality of memory chips.

In operation S110, the memory device 300 may read some data of the second memory chip 340_2 in advance while reading data of the first memory chip 340_1 based on the command/address signal. For example, the interface circuit 320 may transmit the clock signal and the command/address signal to the second memory chip 340_2 in advance while reading the data from the first memory chip 340_1. The memory device 300 may read some data of the second memory chip 340_2 in advance, based on the received clock signal and command/address signal while reading the data of the first memory chip 340_1. In some example embodiments, the size of some data of the second memory chip 340_2 may correspond to the size of the target FIFO register. The memory device 300 may output the data signal (hereinafter, referred to as a first data signal of the second memory chip 340_2) including some data of the second memory chip 340_2 to the interface circuit 320.

In operation S120, the memory device 300 may store some data of the second memory chip 340_2 in the interface circuit 320. For example, the memory device 300 may store some data of the second memory chip 340_2 (or the first data signal of the second memory chip 340_2) to the target FIFO register of the interface circuit 320. Here, the target FIFO register may mean a FIFO register corresponding to the second memory chip 340_2 among the plurality of FIFO registers of the interface circuit 320. The memory device 300 may output some data of the second memory chip 340_2 (or the first data signal of the second memory chip 340_2) stored in the target FIFO register to the memory controller after outputting the data (the data signal of the first memory chip 340_1) read from the first memory chip 340_1. The memory device 300 may output the remaining data of the second memory chip 340_2 (hereinafter, referred to as a second data signal of the second memory chip 340_2) to the interface circuit 320. The interface circuit 320 may store the remaining data of the second memory chip 340_2 (or the second data signal of the second memory chip 340_2) in the target FIFO register. The interface circuit 320 may output the remaining data of the second memory chip 340_2 (or the second data signal of the second memory chip 340_2) stored in the target FIFO register to the memory controller after outputting the some data of the second memory chip 340_2 (or the first data signal of the second memory chip 340_2) to the memory controller. Here, some data of the second memory chip 340_2 (or the first data signal of the second memory chip 340_2) and the remaining data of the second memory chip 340_2 (or the second data signal of the second memory chip 340_2) may be read from the second memory chip 340_2 based on the clock signal (e.g., the read-enable signal) received from the memory controller and may be output to the memory controller based on the clock signal (e.g., the read-enable signal).

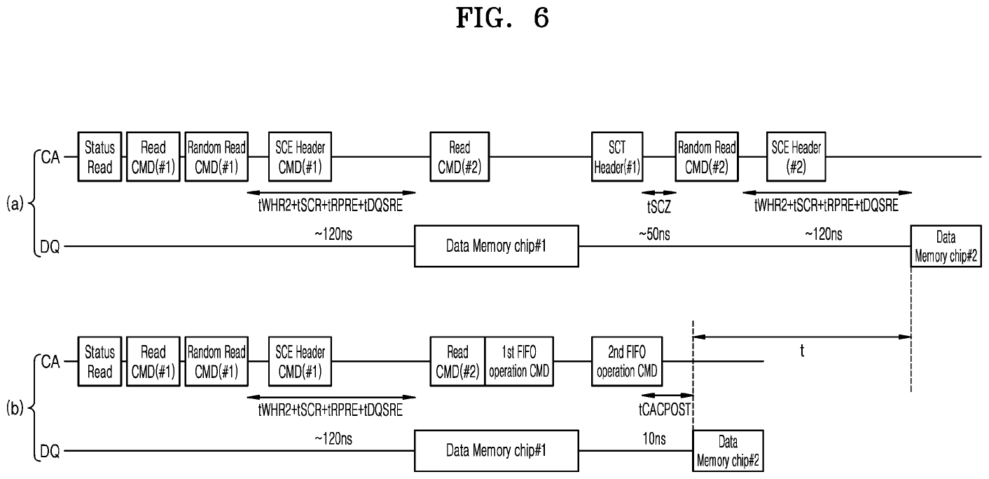

FIG. 6 is a comparison diagram between a memory device according to some example embodiments and a memory device according to a comparative embodiment.

For example, (a) of FIG. 6 represents a timing diagram of an operation (not including a standby performance caused by the FIFO storage of the interface circuit 320) of the memory device according to the comparative embodiment, and (b) of FIG. 6 represents a timing diagram of an operation (including a standby performance caused by the FIFO storage of the interface circuit 320) of the memory device according to some example embodiments of the inventive concepts. Unlike in the memory device according to the comparative embodiment, the memory device 300 according to some example embodiments includes a FIFO storage including a plurality of FIFO registers in the interface circuit 320, and the plurality of FIFO registers respectively correspond to the plurality of memory chips. In FIG. 6, it is assumed that an SCA protocol is applied to both the memory device according to the comparative embodiment and the memory device 300 according to some example embodiments.

Referring to FIG. 6, in (a), the memory device according to the comparative embodiment may perform a read operation on the second memory chip 340_2 sequentially after completing a read operation on the first memory chip 340_1 during the read operation on the plurality of memory chips. That is, the memory device according to the comparative embodiment may read data of the second memory chip 340_2 that is next selected based on the same command/headers after simply reading data of the first memory chip 340_1 selected based on muxing of a multiplexer of the interface circuit 320. Thus, in the read operation of the memory device according to the comparative embodiment, an additional standby time (e.g., tSCZ, tWHR2, (tSCR+tRPRE2+tDQSRE) etc.) (˜about 170 ns) occurs even in the read operation of the second memory chip 340_2 to the occurrence of a standby time (e.g., tWHR2, (tSCR+tRPRE2+tDQSRE) etc.) (˜ about 120 ns) of the read operation of the first memory chip 340_1. Here, the standby time may mean an async time according to the command/address signal and header signal in the read operation of data of each memory device. Thus, in the memory device according to the comparative embodiment, the total read operation time on the plurality of memory chips increases, and thus the I/O efficiency of the memory device is reduced so that the performance of the memory device may be lowered.

In (b), the memory device 300 according to some example embodiments of the inventive concepts may perform some of the read operation on the second memory chip 340_2 in advance (this means a hidden operation of the memory device 300) while performing the read operation on the first memory chip 340_1 during the read operation of the plurality of memory chips. The interface circuit 320 may transmit the command/address signal and clock signal (e.g., a read-enable signal) on the second memory chip 340_2 to the second memory chip 340_2 in advance while performing a read operation on the first memory chip 340_1. The memory device 300 may read some data of the second memory chip 340_2 in advance based on the command/address signal and the clock signal (e.g., a read-enable signal) and transmit the read data to the interface circuit 320, and the interface circuit 320 may store received some data of the second memory chip 340_2 in the target FIFO register. The memory device 300 may output some data of the second memory chip 340_2 stored in the target FIFO register to the memory controller in response to the reception of a first FIFO operation CMD. The memory device 300 may store the remaining data of the second memory chip 340_2 in the target FIFO register and may output the remaining data of the second memory chip 340_2 stored in the target FIFO register to the memory controller in response to the reception of the second FIFO operation CMD. Thus, in the read operation of the memory device 300 according to some example embodiments of the inventive concepts, it may be checked that the standby time (e.g., tWHR2, (tSCR+tRPRE2+tDQSRE) etc.) (˜about 120 ns) of the read operation of the first memory chip 340_1 occurs and an additional standby time (e.g., tCACPOST) (˜about 10 ns) occurs during the read operation of the second memory chip 340_2. The standby time may mean an async time according to the command/address signal and header signal in the read operation of data of each memory device. For example, the memory device 300 according to some example embodiments of the inventive concepts may perform a hidden operation (e.g., perform the read operation of the second memory chip 340_2 during the read operation of the first memory chip 340_1) based on the FIFO storage during the read operation of the plurality of memory chips, thereby reducing the standby time by t-time (about 150 ns) or more compared to the memory device according to the comparative embodiment. It may be expected that, even in the performance index (e.g., KIOPS) of the I/O efficiency of the memory device, the index of the memory device 300 according to some example embodiments of the inventive concepts may have an enhanced value compared to the index of the memory device according to the comparative embodiment.

Thus, referring to (b) of FIG. 6, in the memory device 300 and an operating method thereof according to some example embodiments of the inventive concepts, as the read operation of the second memory chip 340_2 (or some of the read operation) is overlappingly performed as a hidden operation during the read operation of the first memory chip 340_1, the standby time (e.g., async time for the command/address signal and the header signal, etc.) that occurs during the read operation of each memory chip may be reduced (and/or minimized).

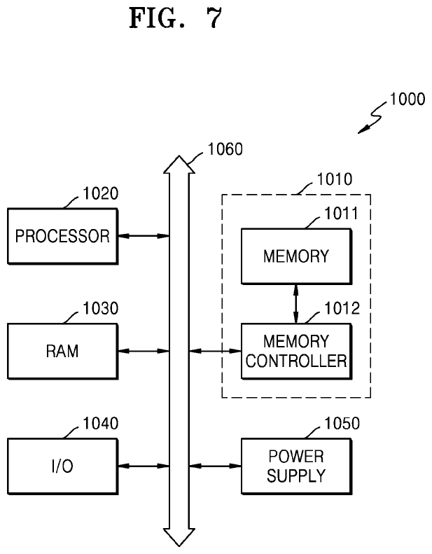

FIG. 7 illustrates a computing system according to some example embodiments.

Referring to FIG. 7, a computing system 1000 may include a memory system 1010, a processor 1020, random access memory (RAM) 1030, an input/output device 1040, and a power supply 1050. Although not shown in FIG. 7, the computing system 1000 may further include a video card, a sound card, a memory card, and ports capable of communicating with a USB device or other electronic devices. The computing system 1000 may be implemented as a personal computer or a portable electronic device such as a laptop computer, a mobile phone, a personal digital assistant (PDA, a camera, or the like.

The processor 1020 may perform specific calculations or tasks. According to some example embodiments, the processor 1020 may be a micro-processor and a central processing unit (CPU). The processor 1020 may perform communication with the RAM 1030, the input/output device 1040, and the memory system 1010 via a bus 1060 such as an address bus, a control bus, a data bus, or the like. According to some example embodiments, the processor 1020 may also be connected to an extended bus, such as a peripheral component interconnect (PCI).

The memory system 1010 may communicate with the processor 1020, the RAM 1030, and the input/output device 1040 via the bus 1060. The memory system 1010 may store the received data or provide the stored data to the processor 1020, the RAM 1030 or the input/output device 1040 according to the request of the processor 1020.

The memory system 1010 may be the memory system 400 described above with reference to FIG. 1. The memory system 1010 may include a memory 1011 and a memory controller 1012. The memory 1011 may correspond to the memory device 300 described above with reference to FIGS. 1 through 6.

The memory controller 1012 may operate based on control of the memory controller 1012 by the operating method according to some example embodiments described above with reference to FIGS. 3 through 5. For example, the memory 1011 may perform the read operation of the second memory chip (or some of the read operation of the second memory chip) while performing the read operation of the first memory chip based on the command/address signal and the clock signal received from the memory controller 1012 through the interface circuit. The memory 1011 may store a data signal of the read operation of the second memory chip (some of the read operation of the second memory chip) in the target FIFO register of the interface circuit. The memory 1011 may output a data signal of the first memory chip to the memory controller 1012 and then output a data signal of the second memory chip stored in the target FIFO register to the memory controller 1012, thereby reducing the standby time (e.g., async time caused by the command/address signal and the header signal for the read operation) of the read operation of the plurality of memory chips and providing the memory system 1010 having the enhanced I/O efficiency.

The RAM 1030 may store data required for the operation of the computing system 1000. For example, the RAM 1030 may be implemented as dynamic RAM (DRAM), mobile DRAM, static RAM (SRAM), PRAM, FRAM, RRAM, and/or MRAM.

The input/output device 1040 may include an input unit, such as a keyboard, a keypad, a mouse, or the like, and an output unit, such as a printer, a display, or the like. The power supply 1050 may supply an operating voltage required for the operation of the computing system 1000.

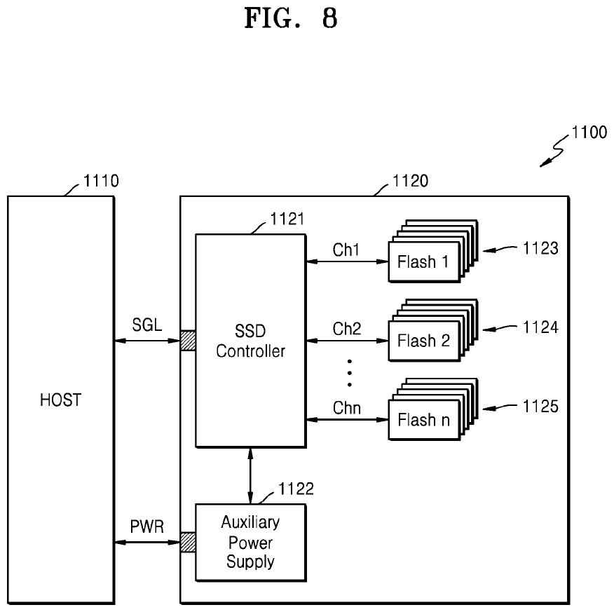

FIG. 8 illustrates a solid state drive (SSD) system according to some example embodiments.

Referring to FIG. 8, an SSD system 1100 may include a host 1110 and an SSD 1120. The SSD 1120 may exchange signals with the host 1110 via a signal connector SGL and may receive power through a power connector PWR.

The SSD 1120 may include an SSD controller 1121, an auxiliary power supply 1122, and a plurality of memory devices 1123, 1124, and 1125. The plurality of memory devices 1123, 1124, and 1125 may be vertical stack-type NAND flash memory devices. At least one of the plurality of memory devices 1123, 1124, and 1125 may correspond to the plurality of memory chips (e.g., the first memory chip 340_1, the second memory chip 340_2, etc.) described above with reference to FIGS. 1 through 7. For example, the SSD 1120 may perform a read operation on another memory device overlappingly while performing the read operation on one of the plurality of memory devices 1123, 1124, and 1125 by the operating method according to some example embodiments described above with reference to FIGS. 1 through 7. Thus, the SSD 1120 may reduce the standby time during the read operation on the plurality of memory devices, and the SSD system 1100 having the enhanced I/O efficiency may be provided.

One or more of the elements disclosed above may include or be implemented in processing circuitry such as hardware including logic circuits; a hardware/software combination such as a processor executing software; or a combination thereof. For example, the processing circuitry may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, an application-specific integrated circuit (ASIC), etc.

As described above, some example embodiments have been disclosed in drawings and specifications. Although some example embodiments have been described using a specific term herein, this is used for the purpose of explaining the technical concepts of the present disclosure, and not to be used to limit the scope of the present disclosure described in meaning or in the claims. Thus, it will be understood by one of ordinary skill in the art that a variety of modifications and equal examples are possible therefrom. Therefore, the true technical protection scope of this disclosure should be determined by the technical concepts of the attached claims.

While the inventive concepts have been particularly shown and described with reference to embodiments thereof, it will be understood that various changes in form and details may be made therein without departing from the spirit and scope of the following claims.

What is claimed is:

1. A memory device comprising:
a plurality of memory chips comprising a first memory chip and a second memory chip; and
an interface circuit comprising a plurality of first-in first-out (FIFO) registers, the plurality of FIFO registers respectively corresponding to the plurality of memory chips,
wherein the memory device is configured to read some data of the second memory chip and to store the read some data in a target FIFO register from among the plurality of FIFO registers of the interface circuit while reading data of the first memory chip, based on a clock signal and a command/address signal received from a memory controller, and the target FIFO register is a FIFO register from among the plurality of FIFO registers corresponding to the second memory chip.

2. The memory device of claim 1, wherein the interface circuit is configured to transmit the command/address signal and the clock signal for the second memory chip in advance while reading the data of the first memory chip.

3. The memory device of claim 2, wherein the memory device is further configured to output the read some data of the second memory chip stored in the target FIFO register to the memory controller after outputting the read data of the first memory chip to the memory controller.

4. The memory device of claim 3, wherein the memory device is further configured to read remaining data of the second memory chip other than the read some data and to store the read remaining data in the target FIFO register of the interface circuit.

5. The memory device of claim 4, wherein the memory device is further configured to output the read remaining data of the second memory chip stored in the target FIFO register to the memory controller after outputting the read some data of the second memory chip.

6. The memory device of claim 5, wherein the read some data of the second memory chip and the read remaining data of the second memory chip are output to the memory controller based on the clock signal received from the memory controller.

7. The memory device of claim 1, wherein the plurality of FIFO registers are electrically connected to respective ones of memory chips from among the plurality of memory chips corresponding to the plurality of FIFO registers and are configured to respectively receive a data signal and a data strobe signal from the plurality of memory chips.

8. The memory device of claim 1, wherein each of the plurality of FIFO registers comprises a plurality of latch circuits.

9. An operating method of a memory device, the memory device comprising an interface circuit and a plurality of memory chips, the operating method comprising:
receiving a clock signal and a command/address signal from a memory controller;
reading some data of a second memory chip from among the plurality of memory chips in advance while reading data of a first memory chip from among the plurality of memory chips based on the command/address signal; and
storing the read some data of the second memory chip in the interface circuit.

10. The operating method of claim 9, wherein the interface circuit comprises a plurality of first-in first-out (FIFO) registers respectively corresponding to the plurality of memory chips.

11. The operating method of claim 9, further comprising transmitting the command/address signal and the clock signal for the second memory chip to the second memory chip in advance while reading the data of the first memory chip.

12. The operating method of claim 10, wherein the storing of the read some data of the second memory chip in the interface circuit comprises storing the read some data of the second memory chip in a target FIFO register from among the plurality of FIFO registers of the interface circuit, and the target FIFO register is a FIFO register from among the plurality of FIFO registers corresponding to the second memory chip.

13. The operating method of claim 12, further comprising outputting the read some data of the second memory chip stored in the target FIFO register to the memory controller after outputting the read data of the first memory chip to the memory controller.

14. The operating method of claim 13, further comprising:
reading remaining data of the second memory chip other than the read some data and storing the read remaining data in the target FIFO register; and
outputting the read remaining data of the second memory chip stored in the target FIFO register to the memory controller after outputting the read some data of the second memory chip to the memory controller.

15. The operating method of claim 14, wherein the read some data of the second memory chip and the read remaining data of the second memory chip are output to the memory controller based on the clock signal received from the memory controller.

16. The operating method of claim 10, wherein the plurality of FIFO registers are electrically connected to respective ones of memory chips from among the plurality of memory chips corresponding to the plurality of FIFO registers and are configured to respectively receive a data signal and a data strobe signal from the plurality of memory chips.

17. The operating method of claim 10, wherein each of the plurality of FIFO registers comprises a plurality of latch circuits.

18. A memory system comprising:
a memory device comprising a plurality of non-volatile memory chips and an interface circuit, the interface circuit comprising a plurality of first-in first-out (FIFO) registers respectively corresponding to the plurality of non-volatile memory chips; and
a memory controller connected to the interface circuit, the memory controller configured to transmit and receive data,
wherein the memory device is configured to read some data of a second non-volatile memory chip from among the plurality of non-volatile memory chips in advance and to store the read some data in a target FIFO register from among the plurality of FIFO registers while reading data of a first non-volatile memory chip from among the plurality of non-volatile memory chips, and the target FIFO register is a FIFO register from among the plurality of FIFO registers corresponding to the second non-volatile memory chip.

19. The memory system of claim 18, wherein the memory device is configured to transmit a clock signal and a command/address signal to the second non-volatile memory chip in advance while reading the data of the first non-volatile memory chip so as to read the some data of the second non-volatile memory chip in advance, and the clock signal received from the memory controller is a read-enable signal.

20. The memory system of claim 19, wherein the memory device is further configured to read remaining data of the second non-volatile memory chip other than the read some data based on the clock signal and to store the read remaining data in the target FIFO register, and to output the read remaining data of the second non-volatile memory chip to the memory controller continuously after outputting the read some data of the second non-volatile memory chip stored in the target FIFO register to the memory controller.
